(19) United States
(12) Patent Application Publication
(10) Pub. No.: US 2021/0041828 A1
(43) Pub. Date: Feb. 11, 2021

(54) APPARATUS BODY STRUCTURE AND IMAGE FORMING APPARATUS

(71) Applicants: Hiroki ISHIMITSU, Kanagawa (JP); Taisuke ISHIKAWA, Kanagawa (JP); Junichi MURANO, Saitama (JP)

(72) Inventors: Hiroki ISHIMITSU, Kanagawa (JP); Taisuke ISHIKAWA, Kanagawa (JP); Junichi MURANO, Saitama (JP)

(73) Assignee: Ricoh Company, Ltd., Tokyo (JP)

(21) Appl. No.: 16/984,532

(22) Filed: Aug. 4, 2020

(30) Foreign Application Priority Data
Aug. 9, 2019 (JP) 2019-148190

(51) Int. Cl. G03G 21/16; B41J 29/02

(52) U.S. Cl. CPC G03G 21/1619; B41J 29/02

(57) ABSTRACT

An apparatus body structure is installed on a floor surface. The apparatus body structure includes at least one side plate. The at least one side plate is installed on the floor surface and includes an upper side plate and a lower side plate. The lower side plate is detachably joined to a lower side of the upper side plate. A floor surface installation position of the lower side plate to be installed on the floor surface is positioned directly below a floor surface installation position of the upper side plate to be installed on the floor surface, when the upper side plate is directly installed on the floor surface without being joined to the lower side plate.

### CROSS-REFERENCE TO RELATED APPLICATION

This patent application is based on and claims priority pursuant to 35 U.S.C. § 119(a) to Japanese Patent Application No. 2019-148190, filed on Aug. 9, 2019, in the Japan Patent Office, the entire disclosure of which is hereby incorporated by reference herein.

### BACKGROUND

### Technical Field

The present disclosure relates to an apparatus body structure and an image forming apparatus.

### Description of the Related Art

As an apparatus body structure installed on a floor surface, there is known an apparatus body structure in which at least one side plate installed on the floor surface includes a lower side plate and an upper side plate and the lower side plate is joined to a lower side of the upper side plate.

### SUMMARY

In an aspect of the present disclosure, an apparatus body structure is installed on a floor surface. The apparatus body structure includes at least one side plate. The at least one side plate is installed on the floor surface and includes an upper side plate and a lower side plate. The lower side plate is detachably joined to a lower side of the upper side plate. A floor surface installation position of the lower side plate to be installed on the floor surface is positioned directly below a floor surface installation position of the upper side plate to be installed on the floor surface, when the upper side plate is directly installed on the floor surface without being joined to the lower side plate.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of a configuration of a copying machine using an electrophotographic method;

FIG. 2A and FIG. 2B are perspective schematic views of printer structures of the copying machine;

FIG. 3 is a perspective view of the printer structure corresponding to FIG. 2A;

FIG. 4 is a perspective view of the printer structure corresponding to FIG. 2B;

FIG. 5 is a front view of a printer front side plate in a state in which a lower side extension plate is joined;

FIG. 6 is a perspective view and a partially enlarged view of the printer front side plate alone;

FIG. 7 is a perspective view of an upper surface of the lower side extension plate;

FIG. 8 is a perspective view of a bottom surface of the lower side extension plate;

FIG. 9 is an enlarged perspective view of a vicinity of a front end portion of a lower left extension stay;

FIG. 10 is a perspective view of the printer front side plate in a state in which the lower left extension stay is removed;

FIGS. 11A and 11B are partially enlarged views of a portion indicated by a rectangular with arrow a in FIG. 10; and

FIG. 12 is an enlarged view of a vicinity of the front end portion of the lower left extension stay.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, embodiments of the present disclosure are described below. In the drawings for explaining the following embodiments, the same reference codes are allocated to elements (members or components) having the same function or shape and redundant descriptions thereof are omitted below.

An embodiment of the present disclosure applied to a body structure of a copying machine as an image forming apparatus is described.

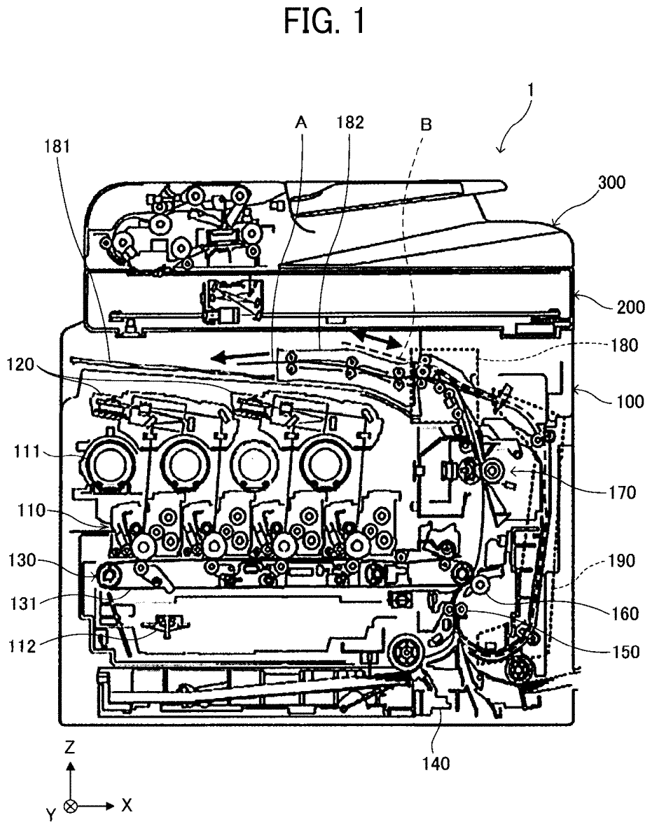

FIG. 1 is a schematic diagram of a copying machine using an electrophotographic method. A copying machine 1 includes a printer 100, a scanner unit 200 as a reading unit placed on the printer 100, and an automatic document feeder (ADF) 300 placed on the scanner unit 200. The copying machine 1 reads a document by the scanner unit 200 using the automatic document feeder 300 or the like to obtain an image signal and forms an image on a transfer sheet (sheet) by the printer 100 according to the image signal. The printer 100 includes an image forming unit 110 for each color of yellow, magenta, cyan and black. A photoconductor as an image bearer, a charger, a developing device, and a cleaning unit are integrated in the image forming unit 110. A latent image formed on the photoconductor by exposure from the writing unit 120 is visualized by the developing device to form a toner image on the photoconductor. Toner images of respective colors are temporarily transferred to an intermediate transfer belt 131 of an intermediate transfer unit 130 in a superimposed manner to form a composite color image.

In single-sided sheet feeding, as indicated by a solid line A in FIG. 1, a transfer sheet is conveyed from a sheet feeding tray 140 as a sheet accommodating portion via a registration roller pair 150. The composite color image is transferred by a secondary transfer roller pair 160 onto the transferred sheet and fixed by a fixing unit 170. Thereafter, the sheet is subjected to post-processing such as sorting and stapling by a finisher 182 provided between a sheet ejection unit 180 and a sheet ejection tray 181, and ejected to the sheet ejection tray 181.

In double-sided sheet feeding, same as in single-sided sheet feeding, a composite color image is transferred to the transfer sheet by the secondary transfer roller pair 160. After the composite color image is fixed by the fixing unit 170, the transfer sheet is branched by the sheet ejection unit 180 as illustrated by a broken line B in FIG. 1, and reversed and ejected to an upper part of the finisher 182. After the transfer sheet passes through a duplex unit 190, the transfer sheet is fed again from the registration roller pair 150 to the secondary transfer roller pair 160, and a composite color image is transferred onto a back surface of the transfer sheet and fixed by the fixing unit 170. Thereafter, the transfer sheet is sorted and stapled and the like by the finisher 182 and ejected to the sheet ejection tray 181. The copying machine 1 in FIG. 1 also includes toner bottles 111 for respective colors of yellow, cyan, magenta, and black and a waste toner bottle 112 common to the colors. Each of the toner bottles 111 contains toner of each color to be supplied to the developing device.

When a new model is developed in which a capability such as the capacity of a sheet feeding tray is enhanced as compared with an existing model that has been sold or developed, a casing to hold an additional sheet feeding device is newly manufactured in addition to an image bearer, a fixing device, a transfer device, a registration roller pair, and the like as in the existing model. In this case, since it is necessary to hold the image bearer, the fixing device, the transfer device, the registration roller pair, and the sheet feeding device with high accuracy, some techniques have been proposed that hold the above-described devices with one side plate.

In a case in which a body structure is newly made without using a body structure used in an existing model, the body structure newly made needs to hold the image bearer, the fixing device, and the like with high accuracy. However, such a body structure with high accuracy needs to be newly made again. For this reason, undesirably it takes time and cost necessary to manufacture components with high accuracy. Although it may be possible to solve the problem by adding an extension member (a lower side plate), undesirably the height accuracy (the levelness of the apparatus) of each components of the apparatus body structure may be deteriorated as compared with a case in which such a lower side plate is not joined.

In view of the above, the present embodiment can maintain a desired accuracy while using a casing of an existing model without remaking a new body structure that requires high accuracy.

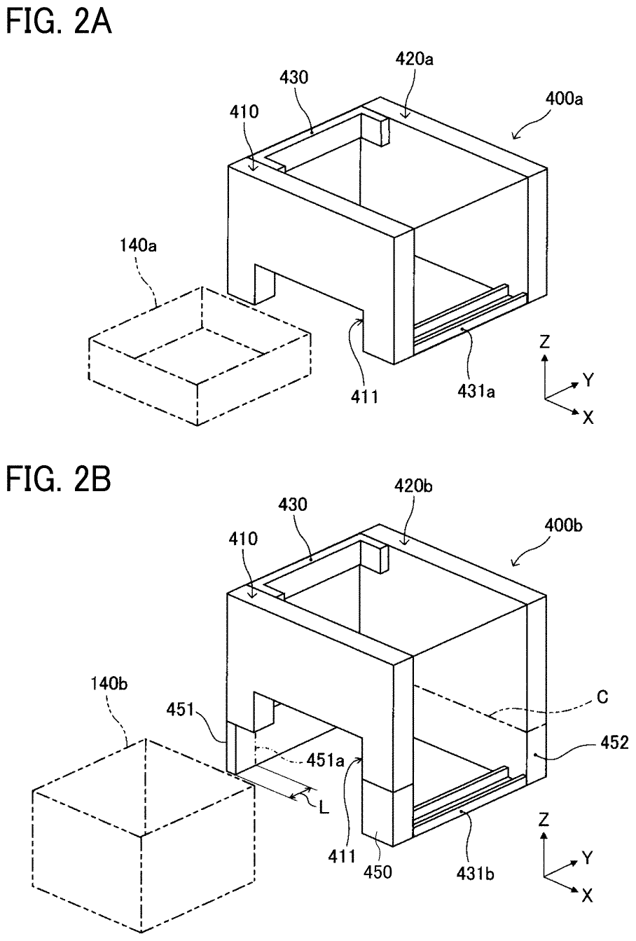

FIG. 2A is a schematic perspective view of a printer structure 400a. The printer structure 400a is an apparatus body structure, which is installed on a floor surface, of an existing model of the copying machine 1 that has been sold or developed. The printer structure 400a is formed by connecting a printer front side plate 410, which is a front side plate of the printer 100, a printer rear side plate 420a, which is a rear side plate of the printer 100, an upper left stay 430, and a lower right stay 431a, and the like. A cassette insertion opening 411 is formed in the printer front side plate 410.

FIG. 2B is a schematic perspective view of a printer structure 400b of a newer model of the copying machine 1 in which a capability such as capacity of a sheet feeding tray has been enhanced. In the printer structure 400b of the newer model of the copying machine 1, the printer front side plate 410, which is a side plate illustrated in FIG. 2A, is used as an upper side plate, and a lower side extension plate 450, which is a lower side plate, is provided below the right side of the printer front side plate 410. In this printer structure 400b, a printer rear side plate 420b is positioned higher than the printer rear side plate 420b in FIG. 2A by the height of the lower side extension plate 450.

Although a lower side extension plate is not provided below the left side of the printer front side plate 410, a lower left extension stay 451 is provided on the lower left side of the printer front side plate 410. An end of the lower left extension stay 451 extends forward by thickness L between a front surface and a rear surface of the printer front side plate 410. A portion indicated by a two-dot chain line 451a is an original end position of the lower left extension stay 451. In the printer structure 400b illustrated in FIG. 2B, an opening extends below the cassette insertion opening 411. Therefore, as indicated by a two-dot chain line, a large-capacity sheet feeding tray 140b having a larger depth than a depth of the sheet feeding tray 140a illustrated in FIG. 2A can be accommodated in the printer structure 400b.

As indicated by a two-dot chain line C, a printer rear side plate same as the printer rear side plate 420a in FIG. 2A may be used for the printer rear side plate 420b, and a rear side extension plate 452 may be provided below the printer rear side plate 420b. Instead of extending the lower left extension stay 451 as described above, a lower side extension plate may be provided below the left side of the printer front side plate 410. In this case, heights of the rear side extension plate 452 and the lower side extension plate provided below the left side of the printer front side plate 410 are all set to the same height as the lower side extension plate 450 in a case of four point installation. In a case of three point installation, the three points are set at the same height.

For example, when the copying machine 1 illustrated in FIG. 2A, is installed at three points, at both left and right sides of printer rear side plate 420a and the right side of the printer front side plate 410, the height of the rear side extension plate 452 illustrated in FIG. 2B is set to be the same as the height of the lower side extension plate 450. The lower side extension plate provided below the left side of the printer front side plate 410 is set to a height such that a lower end of the lower side extension plate floats from the floor in a state in which the copying machine 1 is installed at the three points. Similarly, when the copying machine 1 in FIG. 2A is installed at three points on the rear left side, the rear right side, and the front right side, the lower left extension stay 451 of FIG. 2B is provided such that a bottom end of the lower left extension stay 451 floats from the floor in a state in which the copying machine 1 is installed at the three points.

In the copying machine 1 of the present embodiment, the printer structures 400a and 400b schematically illustrated in FIG. 2B are installed at three points. A description is now given of various structural advantages of the setting of an installation position of the lower side extension plate 450 and the structure of a joint portion between the lower side extension plate 450 and the printer front side plate 410 as an upper side plate with respect to the lower side extension plate 450. The structural advantages are designed so that the height accuracy of each component supported by the printer structure 400a illustrated in FIG. 2A is also maintained in the printer structure 400b illustrated in FIG. 2B. Hereinafter, specific examples are described.

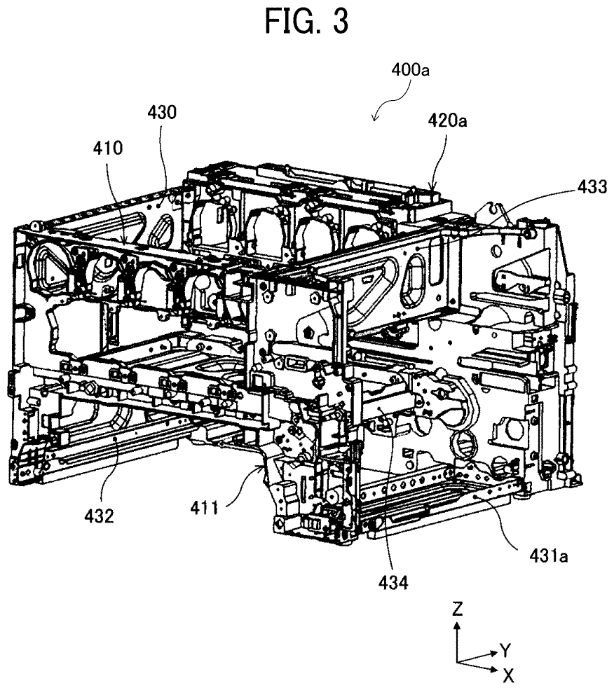

FIG. 3 is a perspective view of the printer structure 400a corresponding to FIG. 2A. The printer front side plate 410 and the printer rear side plate 420a are side plates to hold the image bearer, the fixing device, the transfer device, the registration roller pair, and the like therebetween with high accuracy. The printer structure 400a is installed at a total of three points, that is, two points at bottom portions of the left and right ends of the printer rear side plate 420a and one point at a bottom portion of the right end of the printer front side plate 410. The left bottom portion of the printer front side plate 410 floats from the floor surface.

The printer front side plate 410 and the printer rear side plate 420a are joined by an upper left stay 430, a lower right stay 431a, a lower left stay 432, a fixing stay 433, and a base 434 to constitute the printer structure 400a. The base 434 is a flat sheet metal and determines front, rear, left and right positions of the printer front side plate 410 and the printer rear side plate 420a. The base 434 and the upper left stay 430, the lower right stay 431a, the lower left stay 432, and the fixing stay 433 stay are mounted on the printer front side plate 410 and the printer rear side plate 420a to ensure the rigidity of the printer structure 400a. For example, a sheet feeding tray 140a that accommodates 250 sheets can be inserted from the cassette insertion opening 411 of the printer front side plate 410.

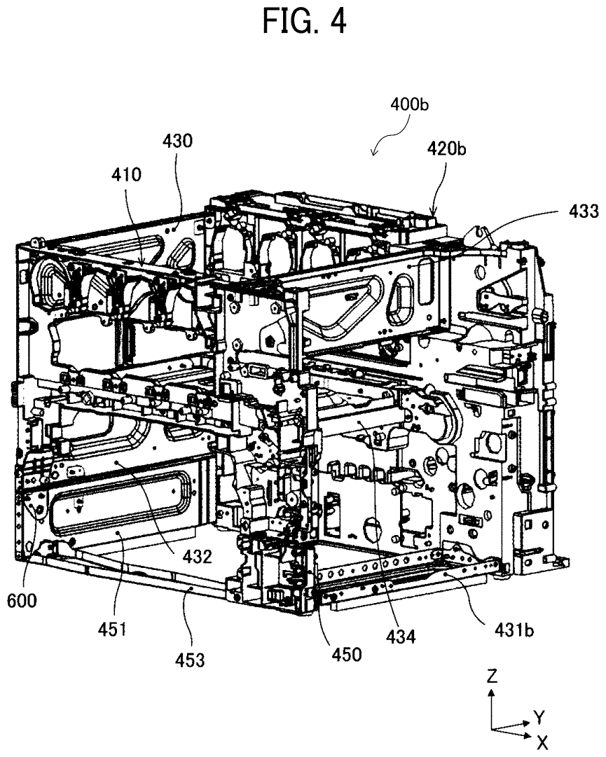

FIG. 4 is a perspective view of the printer structure 400b corresponding to FIG. 2B. The printer structure 400b can accommodate a sheet feeding tray 140b that accommodates 500 sheets using the printer structure 400a of FIG. 3. The lower side extension plate 450 is provided below the right side of the printer front side plate 410 to accommodate the sheet feeding tray 140b for 500 sheets. The printer rear side plate 420b is positioned higher than the printer rear side plate 420a in the example of FIG. 3 by the height of the lower side extension plate 450. A sheet feeding method is different between the copying machine 1 including the sheet feeding tray 140a for 250 sheets and the copying machine 1 including the sheet feeding tray 140b for 500 sheets. A printer rear side plate including a driver is not a combination of separate parts, but a newly integrated member. If the sheet feeding method is the same, as described with reference to FIG. 2B, a method of coupling a lower extension plate as a separate component to the printer rear side plate 420a can be adopted, similar to the case in which the lower side extension plate 450 is joined to the printer front side plate 410.

As illustrated in FIG. 4, the lower left extension stay 451 is provided as in FIG. 2B. Unlike the lower right stay 431a in FIG. 3, a lower right stay 431b is provided to join the printer rear side plate 420b and the lower side extension plate 450. A front lower stay 453 is provided so as to join the lower left extension stay 451 and the lower side extension plate 450. The copying machine 1 including the sheet feeding tray 140b for 500 sheets has a long shape portion serving as a foot extending from the base 434 to the floor surface. The long shape portion is not integrated with the base 434, but a separate member for extension. Hence, the front lower stay 453 is added to enhance the accuracy of the lower left and right spans.

In joining the lower side extension plate 450 to configure the copying machine 1 including the sheet feeding tray 140b for 500 sheets, if the floor surface installation position of the lower side extension plate 450 installed on the floor surface is different from the floor surface installation position of the printer front side plate 410 directly installed on the floor surface as the copying machine 1 including the sheet feeding tray 140a for 250 sheets, the load balance may be different and the height accuracy of each component may be different, undesirably. In particular, in a case in which the copying machine 1 is installed at three installation points as in the present embodiment, the height accuracy of each component is more likely to be different. Therefore, in the present embodiment, in the case of the printer structure 400a of FIG. 3 alone in which the printer front side plate 410 is directly installed on the floor surface without being joined to the lower side extension plate 450, a position on a bottom surface of the lower side extension plate 450 corresponding to a position directly below the floor surface installation position of the printer structure 400a is set as the floor surface installation position.

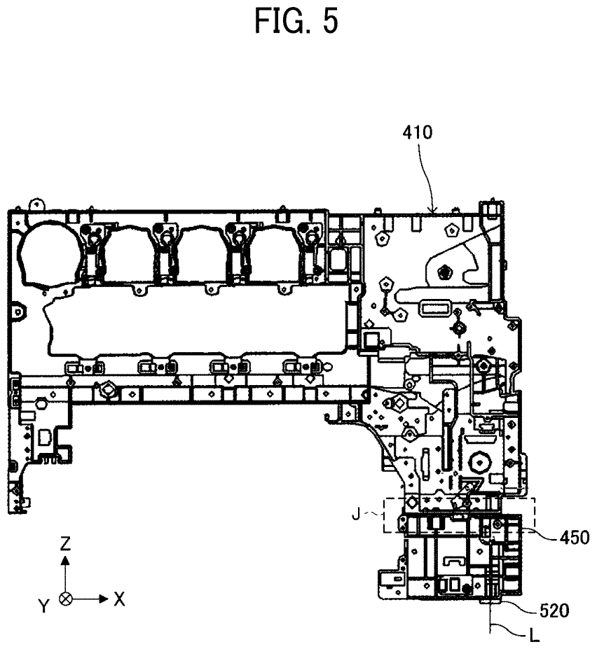

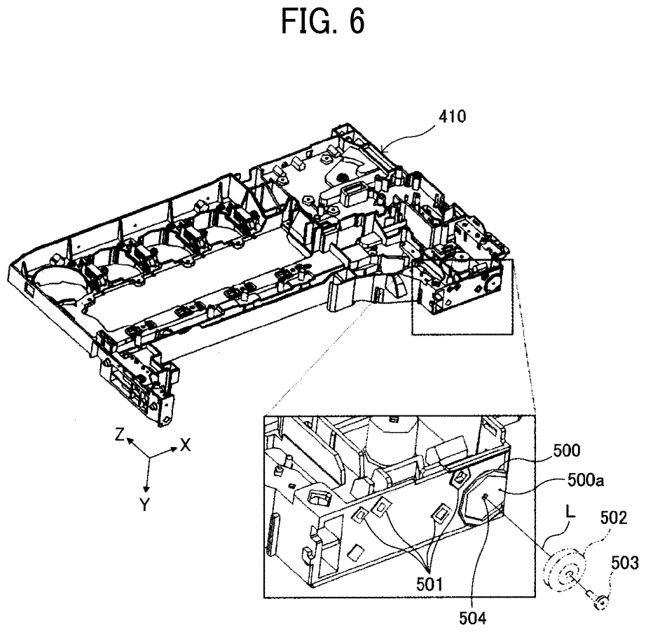

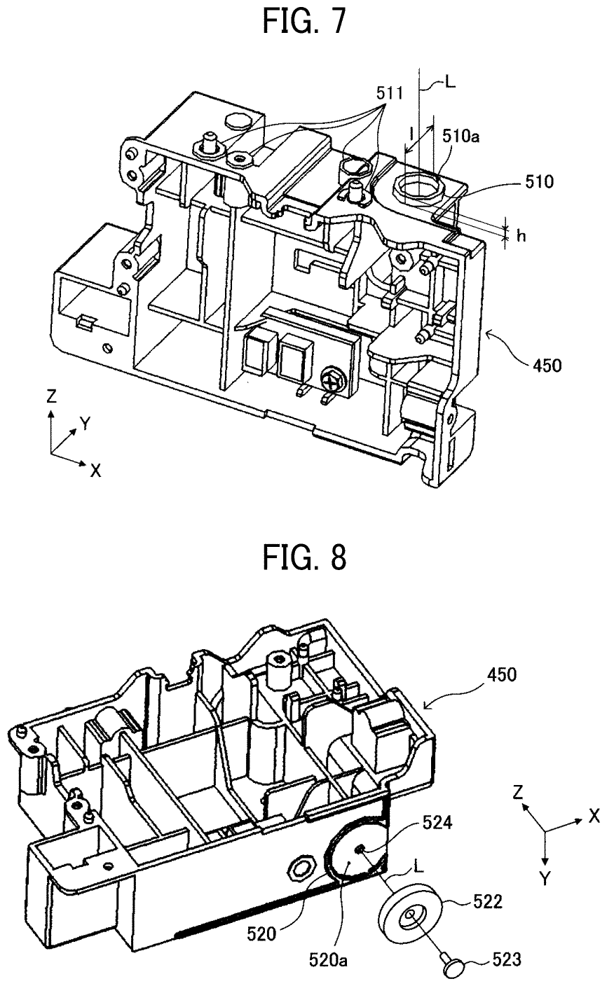

FIG. 5 is a front view of the printer front side plate 410 in a state in which the lower side extension plate 450 is joined with the printer front side plate 410. FIG. 6 is a perspective view of the printer front side plate 410 alone and a partially enlarged view of the printer front side plate 410. FIG. 7 is a perspective view of an upper side of the lower side extension plate 450. FIG. 8 is a perspective view of a bottom side of the lower side extension plate 450.

A frame J in FIG. 5 indicates a joint portion in which a lower right surface of the printer front side plate 410 and an upper surface of the lower side extension plate 450 are joined. As illustrated in FIG. 6, an annular projection 500 serving as a floor surface installation position reference is formed on a joint portion of the printer front side plate 410 when the printer structure 400a alone is installed. An inner portion of the annular projection 500 is a rubber foot mounting surface 500a on which a rubber foot is mounted. The annular projection 500 indicates a rubber foot mounting position, and consequently indicates the floor surface installation position.

In the partially enlarged view of FIG. 6, imaginary lines (two-dot chain lines) indicate a rubber foot 502 mounted on the rubber foot mounting surface 500a and a securing screw 503 when the printer front side plate 410 is used alone for the copying machine 1 including the sheet feeding tray 140a for 250 sheets. The rubber foot 502 has, for example, a disk shape, and a recess to accommodate a head portion of the securing screw 503 and a screw-through hole are formed in a center portion of the rubber foot 502. A screw hole 504 into which the securing screw 503 is screwed is formed in a center of the rubber foot mounting surface 500a. The screw hole 504 also serves as a floor surface installation position reference that indicates the rubber foot mounting position. The rubber foot 502 and the securing screw 503 may be integrated, and the integrated rubber foot 502 may be rotated to be fixed to the screw hole 504. The floor installation position reference may indicate the rubber foot mounting position by coloring and the like instead of indicating the rubber foot mounting position by shape such as by the annular projection 500 or the screw hole 504.

Instead of adding a separate installation component such as the rubber foot, an installation portion may be integrally formed. In this case also, the installation position is indicated by shape, color, or the like, and may serve as an installation position reference.

The thickness of the rubber foot 502 is larger than the height of the annular projection 500. The rubber foot 502 protrudes most downward from a lower surface of the printer front side plate 410 in a state in which the rubber foot 502 is mounted. Therefore, in the case of the copying machine 1 including the sheet feeding tray 140a for 250 sheets, the copying machine 1 is installed on the floor surface with the rubber foot 502. Similar shaped portions to mount rubber feet are also formed on lower surfaces of the left and right ends of each of the printer rear side plate 420a of the copying machine 1 including the sheet feeding tray 140a for 250 sheets and of the printer rear side plate 420b of the copying machine 1 including the sheet feeding tray 140b for 500 sheets. The rubber feet are fixed to install the copying machine 1 with the rubber feet.

The partially enlarged view of FIG. 6 also indicates an imaginary vertical line L that passes through the center of the rubber foot mounting surface 500a (the center of the screw hole 504). As illustrated in FIGS. 5 and 8, an annular projection 520 is formed on the lower surface of the lower side extension plate 450. The annular projection 520 includes a rubber foot mounting surface 520a. The vertical line L also passes through the center of the rubber foot mounting surface 520a. The annular projection 520 is also a floor surface installation position reference. As illustrated in FIG. 8, the inner portion of the annular projection 520 is the rubber foot mounting surface 520a to mount the rubber foot, and a screw hole 524 to screw a securing screw 523 is formed at the center of the rubber foot mounting surface 520a. A rubber foot 522 is secured to the rubber foot mounting surface 520a by the securing screw 523. The rubber foot 522 and the securing screw 523 may be integrated. The thickness of the rubber foot 522 is also larger than the height of the annular projection 520. The rubber foot 522 protrudes most downward from the lower surface of the lower side extension plate 450, and the lower side extension plate 450 is installed on the floor surface with the rubber foot 522.

As described above, the position of the rubber foot 522 is set immediately below the rubber foot 502. That is, in the case of the printer structure 400a alone illustrated in FIG. 3 in which the printer front side plate 410 is directly installed on the floor surface without being joined to the lower side extension plate 450, the rubber foot 522 is provided on a bottom surface of the lower side extension plate 450 to form the front surface installation position. The bottom surface of the lower side extension plate 450 corresponds to a position directly below the rubber foot 502 that is the floor surface installation position. Accordingly, even in the case in which the copying machine 1 including the sheet feeding tray 140b for 500 sheets is constituted, the load balance and the height accuracy of each component equivalent to the case of the copying machine 1 including the sheet feeding tray 140a for 250 sheets can be obtained. When the lower side extension plate 450 is joined, the positional accuracy may be degraded if the lower surface of the printer front side plate 410 and the upper surface of the lower side extension plate 450 are simply joined to each other in a face-to-face manner. Therefore, in the present embodiment, the joint portion of the printer front side plate 410 at which the printer front side plate 410 is joined to the lower side extension plate 450 is used as the floor surface installation position in the case in which the printer front side plate 410 is directly installed on the floor surface when the printer front side plate 410 is not joined to the lower side extension plate 450. In addition, the joint portion of each of the printer front side plate 410 and the lower side extension plate 450 has a convex shape.

The convex shape is formed for the following reason. That is, if the joint portion of the printer front side plate 410 and the lower side extension plate 450 are joined over the entire surfaces of the joint portions, the shape accuracy such as flatness is required with high accuracy over the entire surfaces of the joint portions, which leads to an increase in processing cost. In particular, in the case of resin molding, it is difficult to mold the side plates. If a projection is provided in part and the high accuracy is set only for the projection, the processing cost can be reduced and the molding of resin can be simplified. Hereinafter, the convex shape is specifically described.

As illustrated in FIG. 7, an annular projection 510 is formed on the upper surface of the lower side extension plate 450 around the vertical line L passing through the center of the rubber foot mounting surface 500a illustrated in FIG. 6. The vertical line L passes through the center of the annular projection 510. The outer diameter I of the annular projection 510 (see FIG. 7) is smaller than the diameter of the rubber foot mounting surface 500a, and the entirety of the annular projection 510 can be accommodated within the rubber foot mounting surface 500a. The height h of the annular projection 510 is set higher than the height of the annular projection 500 of the printer front side plate 410. Accordingly, the annular projection 510 having a convex shape portion can be joined to the rubber foot mounting surface 500a which is the installation position of the printer front side plate 410.

As illustrated in the enlarged view of FIG. 6, four window-frame-shaped projections 501 are also formed on the joint portion of the printer front side plate 410. As illustrated in FIG. 7, four projections 511 are formed at the joint portion of the lower side extension plate 450. The projected end position (height) of each of the projections 511 is set so that the four projections 501 are also joined to the corresponding projections 511 of the lower side extension plate 450 in a state in which the annular projection 510 is joined to the rubber foot mounting surface 500a. Such a configuration disperses the load applied to the joint portion between the annular projection 510 and the rubber foot mounting surface 500a.

The above-described structure can also be used when a configuration of joining a lower side extension plate as a separate component to the printer rear side plate 420a is adopted similarly to the case of the printer front side plate 410.

When the copying machine 1 is installed at four points on the floor surface, the joint configuration as described above is adopted for all the four points. However, when flatness (height accuracy of each component) with high accuracy needs to be secured to prevent color shift as in a color copying machine, the installation at three points is advantageous. Even in the present embodiment, the left side of the printer front side plate 410 is floated from the floor surface. As described with reference to FIG. 2B, the lower side extension plate as a separate component is not joined to the left side of the printer front side plate 410, but the lower left extension stay 451 joining the printer front side plate 410 and the printer rear side plate 420b is extended to the front surface of the printer structure, thereby ensuring the rigidity of the body structure and reducing the number of components and the cost.

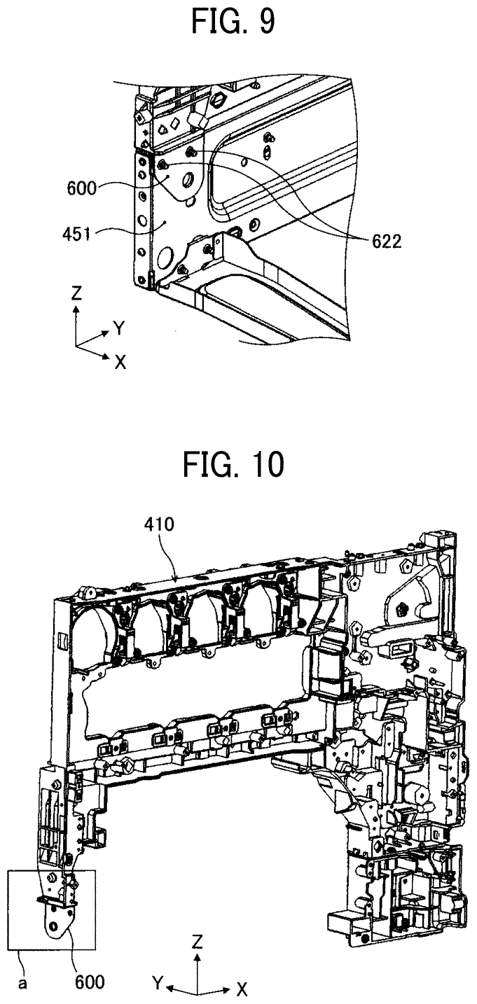

A specific example of the lower left extension stay 451 is described. FIG. 9 is an enlarged perspective view of a vicinity of a front end portion of the lower left extension stay 451. A bracket 600 connects the front end portion of the lower left extension stay 451 to the printer front side plate 410. A screw 622 secures the lower left extension stay 451 to the bracket 600.

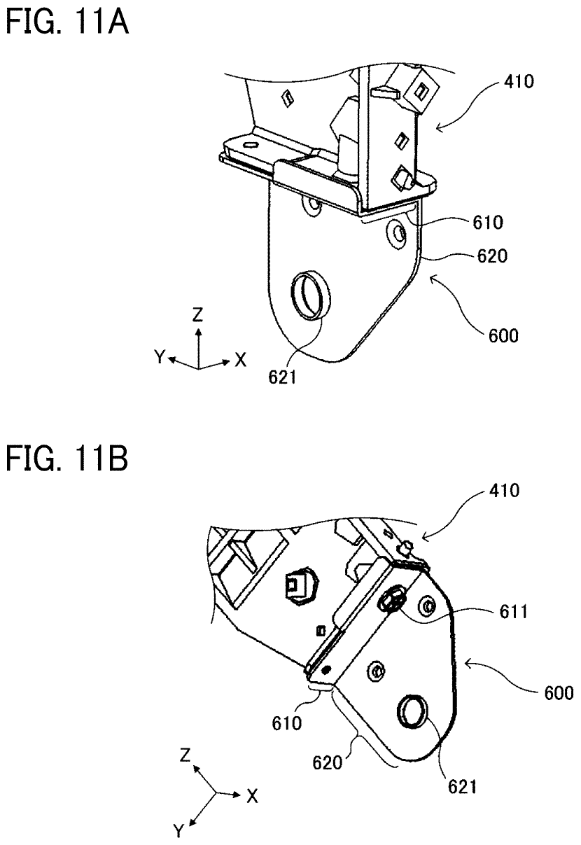

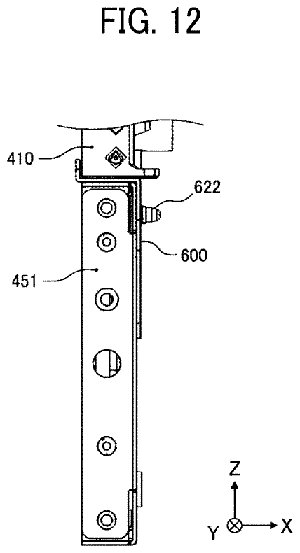

FIG. 10 is a perspective view of the printer front side plate 410 in a state in which the lower left extension stay 451 is removed from the printer front side plate 410. FIG. 11A is an enlarged view of an area indicated by a frame a in FIG. 10. FIG. 11B is a perspective view of the area indicated by the frame a as viewed from a different angle. FIG. 12 is an enlarged front view of a vicinity of the front end portion of the lower left extension stay 451.

As illustrated in FIGS. 11A and 11B, the bracket 600 includes a horizontal portion 610 and a hanging portion 620. The horizontal portion 610 is fixed to the printer front side plate 410 by a fixing screw 611. The hanging portion 620 includes a burring portion 621. The lower left extension stay 451 is set so that the burring portion 621 fits in a hole formed in a side wall of the lower left extension stay 451. In such a state, as illustrated in FIG. 12, a front end of the lower left extension stay 451 is fixed to the hanging portion 620 by the screw 622. A rear end of the lower left extension stay 451 is fixed to the printer rear side plate 420b by a known method. In such a state in which the lower left extension stay 451 is fixed as described above, a front end surface of the lower left extension stay 451 coincides with a front end surface of the printer front side plate 410.

According to the present embodiment described above, the height of the components supported by the printer structure 400b can be increased than in the case in which the printer front side plate 410 is directly installed on the floor surface. Accordingly, a large-capacity tray having a large depth and capable of accommodating a larger number of sheets can be accommodated as a sheet feeding tray. In addition, the rubber foot mounting surface 500a provided on the printer front side plate 410 and the annular projection 510 of the convex shape provided on the lower side extension plate 450 join the printer front side plate 410 and the lower side extension plate 450. If the printer front side plate 410 and the lower side extension plate 450 are not joined at the rubber foot mounting surface 500a, in a case of the copying machine 1 including the sheet feeding tray 140b for 500 sheets, the installation points on the floor surface are different from the case of the copying machine 1 including the sheet feeding tray 140a for 250 sheets. As a result, the accuracy of the image forming unit, which is a common unit to both the copying machine 1 including the sheet feeding tray 140b for 500 sheets and the copying machine 1 including the sheet feeding tray 140a for 250 sheets, cannot be obtained as in the case of the copying machine 1 including the sheet feeding tray 140a for 250 sheets. On the other hand, in the printer structure 400a of the copying machine 1 including the sheet feeding tray 140a for 250 sheets, the annular projection 510 projects from a lower side plate toward the rubber foot mounting surface 500a to join the printer front side plate 410. Thus, the configuration for installation can be equivalent for both the copying machine 1 including the sheet feeding tray 140a for 250 sheets and the copying machine 1 including the sheet feeding tray 140b for 500 sheets, while ensuring the positional accuracy in the height direction. Providing the rubber foot 522 on the lower side extension plate 450 at the position directly below the rubber foot 502 mounted on the printer front side plate 410 ensures accuracy even if the side plates are vertically joined, and the installed state after the side plates are joined can be equivalent with the installed state before the side plates are joined. That is, since the installation positions are aligned in the vertical direction, the load balance of the body structure and the height accuracy of each component can be maintained.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present disclosure.

What is claimed is:

1. An apparatus body structure configured to be installed on a floor surface, the apparatus body structure comprising at least one side plate configured to be installed on a floor surface,
the at least one side plate including:
an upper side plate; and
a lower side plate detachably joined to a lower side of the upper side plate,
wherein a floor surface installation position of the lower side plate to be installed on the floor surface is positioned directly below a floor surface installation position of the upper side plate to be installed on the floor surface when the upper side plate is directly installed on the floor surface without being joined to the lower side plate.

2. The apparatus body structure according to claim 1,
wherein a joint portion of the upper side plate at which the upper side plate is joined to the lower side plate is at the floor surface installation position of the upper side plate.

3. The apparatus body structure according to claim 1, further comprising a floor surface installation position reference portion at the floor surface installation position for each of the upper side plate and the lower side plate.

4. The apparatus body structure according to claim 1,
wherein a joint portion at which the upper side plate is joined to the lower side plate has a convex shape.

5. The apparatus body structure according to claim 1,
wherein the apparatus body structure is installed at three points on the floor surface,
wherein a first point and a second point of the three points are at a left end and a right end, respectively, of a rear side plate,
wherein one of the at least one side plate is a front side plate and another of the at least one side plate is a rear side plate,
wherein the lower side plate is joined to one end of a left end and a right end of the front side plate to form a third point of the three points,
wherein the lower side plate is not joined to the other end of the left end and the right end of the front side plate, the other end being not installed on the floor surface, and
wherein the apparatus body structure further comprises a stay extending to the other end of the front side plate and connecting the other end of the front side plate and the rear side plate.

6. The apparatus body structure according to claim 1, further comprising a sheet accommodating portion at a lower area of the apparatus body structure,
wherein, when the upper side plate and the lower side plate are joined, the sheet accommodating portion has a larger sheet capacity than when the upper side plate and the lower side plate are not joined.

7. An image forming apparatus comprising the apparatus body structure according to claim 1.
